(19) United States
(12) Patent Application Publication
(10) Pub. No.: US 2022/0274278 A1
(43) Pub. Date: Sep. 1, 2022

(54) Bale handling apparatus with wrap remover

(71) Applicant: HILLCO TECHNOLOGIES, INC., Nezperce, ID (US)

(72) Inventors: Leonard Hill, Nezperce, ID (US); Scott Wemhoff, Kamiah, ID (US)

(21) Appl. No.: 17/638,024

(22) PCT Filed: Aug. 26, 2020
(86) PCT No.: PCT/US20/47982

§ 371 Date: Feb. 24, 2022

Related U.S. Application Data
(60) Provisional application No. 62/892,455, filed on Aug. 27, 2019.

(51) Int. Cl. B26D 7/02

(52) U.S. Cl. CPC B26D 7/02; A01D 87/127

(57) ABSTRACT

An apparatus for lifting, moving, and dispersing bales of material while retaining and separating wrap material from the baled material. The apparatus contains grasping features which are movable to grasp and release bales of various sizes. Grasping features further contain features to grasp and sever wrap material while minimally cutting the baled material.

### TECHNICAL FIELD

This invention relates to apparatuses for handling baled material and separating bale contents from wrap material.

### BACKGROUND ART

Agriculture poses a variety of health and safety risks as a number of activities are dangerous and performed under adverse conditions. Climbing onto tractors and climbing off tractors on uneven ground poses risks of slipping, falling, and becoming injured. Using sharp knives to cut wrap material poses risks of cutting one's self. Agriculture also is under continual pressures to operate efficiently as profit margins are often small. For these reasons, numerous devices have been invented over the years seeking to both reduce risks and increase efficiency by use of more mechanized processes and increasing physical distance between processes and people.

Feed for animals is often cut and dried in fields and accumulated into bales for storage and transportation. The bales are often then “fed” to animals. In order to minimize feed losses, the bales are often cut open and the contents of the bale distributed. Sometimes, the bales are “ground” through a grinder. If the wrap material is not removed prior to grinding, animals often ingest significant amounts of wrap material. When the wrap material is not digestible, this wrap material can accumulate in animals' stomachs. This is of particular concern when feeding animals which are not near slaughter.

There are two general shapes of bales based on the machine used to create the bales: square (or rectangular) and round (or cylindrical). At the time of this applications, industry-standard “large round” bale sizes include, but are not necessarily limited to, 4′×4′, 4′×5′, 4′×6′, 5′×5′, 5′×6′. At the time of this applications, industry-standard “large square” bale sizes include, but are not necessarily limited to, 3′×3′×8′, 3′×4′×8′, and 4′×4′×8′.

There are various materials used to wrap vegetation into bales. These materials include, but are not necessarily limited to, baling wire, cotton twine, jute twine, nylon twine, polypropylene twine, sisal twine, pvc wrap, silage wrap, stretch netting (net wrap). Most wrap material is not digestable and some, like baling wire, can pose substantial health risks to animals. Different wrap materials offer different advantages. Silage wrap can allow uncovered storage and create an anaerobic environment which minimizes mold and other degradation though silage wrap is relatively expensive and requires more careful handling. Twines are relatively inexpensive, but are prone to breaking.

### DISCLOSURE OF INVENTION

The invention of the instant application is an apparatus for grasping, lifting, moving, and dispersing bales of vegetation while retaining and separating wrap material from the baled vegetation. Generally speaking, the apparatus is an article of manufacture configured to 1) grasp and lift a unit of baled vegetation, 2) relocate the baled vegetation to a desired location, 3) capture the wrap material used to bale the vegetation, 4) sever the wrap material, 5) release the baled vegetation, 6) withdraw the wrap material, and 7) release the wrap material. In a preferred embodiment, the apparatus is configured to be attached to a vehicle such as a tractor, skid steer loader, tele-handler loader, or front-end loader. In an alternative embodiment, the apparatus is integral to a vehicle.

In a preferred embodiment, the article of manufacture is configured with a plurality of prongs 102 and 104 spaced an appropriate distance apart to be slightly wider than a bale 1402, 1602, and 1702. The distance between prongs 102 and 104 is adjustable; the space between prongs 102 and 104 may be decreased to grasp bale 1402, 1602, or 1702 and increased to release bale 1402, 1602, or 1702 based on input administered through a control system. In a preferred embodiment, both prongs 102 and 104 are movable 702 and 704. In a preferred variation of this embodiment, prongs 102 and 104 are connected through a force-equalizing control system such that equal amounts of force are applied to prongs 102 and 104. This allows bale 1402, 1602, or 1702 to be grasped without significantly moving bale 1402, 1602, or 1702 from its location relative to the apparatus.

In an alternative embodiment, one prong 102 or 104 is stationary and one prong 104 or 102 is movable. In an alternative embodiment, the apparatus is configured such that stationary prong 102 or 104 may be attached at various positions. In a preferred variation of this embodiment, these various positions are different distances from movable prong 104 or 102 such that, by attaching stationary prong 102 or 104 at different positions, different bale 1402, 1602, or 1702 widths may be handled. In a preferred variation of this embodiment, these bales 1402, 1602, or 1702 of various widths may be grasped by the apparatus. In a preferred embodiment, the range of motion of movable prong 104 or 102 is selected in conjunction with the various spacing positions for stationary prong 102 or 104. In one exemplary embodiment, when movable prong 104 or 102 has a range of motion of 24 inches, the various attachment positions are be selected to be 12 inches apart to allow overlap between the range of motion and attachment positions. In a preferred embodiment, the various spacing positions for stationary prong 102 or 104 are also selected based on industry-standard bale 1402, 1602, or 1702 sizes such that when movable prong 104 or 102 is in its widest position, the distance between prongs 102 and 104 is greater than the width of bale 1402, 1602, or 1702 to be handled and when movable prong 104 or 102 is in its narrowest position, the distance between prongs 102 and 104is less than the width of the bale 1402, 1602, or 1702 to be handled.

In a preferred embodiment, the apparatus is configured with a plurality of spikes 202 configured to pierce bale 1402, 1602, or 1702 and support the weight of bale 1402, 1602, or 1702. In one variation of this embodiment, the plurality of spikes 202 are generally parallel to prongs 102 and 104. In a second variation of this embodiment, the plurality of spikes are attached to one or more of the prongs extending toward an opposing prong. In a third variation, the apparatus is configured with a combination of features of the first and second variations.

In a preferred embodiment, the tractor to which the article is attached is configured with locomotive means such as a motor, driving controls, and tires or treads. In an alternative embodiment, when the apparatus is integral to a vehicle, the vehicle is configured with locomotive means such as a motor, driving controls, and tires or treads. In a second alternative embodiment, the apparatus is configured for stationary operation.

In a preferred embodiment, the tractor to which the article is attached is configured with lifting means whereby prongs 102 and 104 may be raised and lowered. In operation, the prongs 102 and 104 of the apparatus are placed on either side of bale 1402, 1602, or 1702. The width between prongs 102 and 104 is reduced thereby pinching or grabbing bale 1402, 1602, or 1702. Prongs 102 and 104 are then raised lifting bale 1402, 1602, or 1702 off the ground. Once lifted, bale 1402, 1602, or 1702 may be stacked on another bale 1402, 1602, or 1702, relocated, and/or distributed.

In a preferred embodiment, one prong 104 is configured with features configured to capture and release wrap material. In a preferred embodiment, the wrap material capture means are a plurality of hooks 602. In a preferred embodiment, these hooks 602 open and close along substantially the entirety of the length of prong 104. In a preferred embodiment, in an open configuration, hooks 602 are recessed in prong 104. In a preferred embodiment, when moved from an open configuration to a closed configuration, hooks 602 each pivot around respective fixed locations, move toward opposing prong 102 in a plane generally defined by prongs 102 and 104 (approximately perpendicular to wrap material) and continue to move until the tips of hooks 602 are again recessed in prong 104. In an alternative embodiment, hooks 602 operate in a plane approximately orthogonal to prong 104 containing hooks 602. In this alternative embodiment only certain wrap materials, such as net wrap or silage wrap, are likely to be grasped by hooks 602. In a preferred embodiment, the features configured to release the wrap material are hooks 602 operating from a closed configuration to an open configuration.

In a preferred embodiment, prong 104 containing the features 602 configured to capture the wrap material is configured with depth adjustment features. In a preferred embodiment these adjustment features comprise draw bolt features 604, 606, and 608 whereby the distance of the capture features from the face of prong 104 may be changed. In this preferred embodiment, bolts 604 are captive but may rotate. Nuts 608 are secured to a plate 610 to which hooks 602 are attached. Nuts 608 are prevented from rotating relative to plate 610, such as by welding them to plate 610. When bolt 604 is rotated, plate 610 is drawn closer or pushed farther from the front face of prong 104. The depth of plat 610 may be secured by tightening jam nuts 606 against either plate 610 or the back of the front face of prong 104. In an alternative embodiment, these depth adjustment features comprise a series of plates having different thicknesses configured to be installed on a face of prong 104 containing the wrap material capture means. When a thicker plate is installed, hooks 602 in a closed configuration, are closer to the plate thereby causing hooks 602 to reach less deeply into bale 1402, 1602, or 1702 when grasping wrap material and providing a tighter grasp on that wrap material. In an alternative embodiment, these depth adjustment features comprise control system elements which manage the amount of hook 602 rotation whereby greater rotation results in the hooks providing a smaller gap and tighter grasp and lesser rotation results in hooks 602 providing a larger gap and less tight grasp. In a second alternative embodiment, the depth of the hook 602 fulcrum (or effective point around which the hooks 602 rotate when opening and/or closing) beneath the face of prong 104 is adjustable to provide a tighter and/or less-tight grasp.

In a preferred embodiment, the apparatus is configured with features to sever the wrap material. In a preferred embodiment, these features comprise knife 502. In a preferred embodiment, knife 502 is contained in prong 102. In a preferred embodiment, when not engaged, knife 502 is recessed beneath a surface of prong 102. In a preferred embodiment, when engaged, the edge of knife 102 extends beyond a surface of prong 102. In a preferred embodiment, when activated, knife 102 moves from a not engaged position to an engaged position. In a preferred embodiment, knife 102 moves from a not engaged position to an engaged position by moving in an orbital motion, or portion thereof. In an alternative embodiment, knife 102 moves from a not engaged position to an engaged position by moving at an angle which is between parallel to a face of prong 102 and perpendicular to the face of prong 102. In a preferred embodiment, knife 502 is comprised of a single blade having a serrated cutting edge. In an alternative embodiment knife 502 is comprised of a single blade having a straight edge.

In an alternative embodiment, features to sever the wrap material comprise a series of circular blades. In yet another alternative embodiment, the features comprise a chain with a plurality of cutting elements attached thereto. In preferred embodiments, the features to sever the wrap material cut into bale 1402, 1602, or 1702 a minimal amount necessary to sever the wrap material and do not cut all the way through bale 1402, 1602, or 1702. The knife 502, knives, circular blades, and chain are exemplary embodiments. Other means of severing the wrap material are anticipated and may be practiced without deviating from the present invention.

In a preferred embodiment, prongs 102 and 104 are rotateable from a horizontal orientation to a vertical orientation. In a horizontal orientation, prongs 102 and 104 are used to grasp, lift, move, sever wrap material, disperse bale contents, and remove wrap material. In a vertical orientation, prongs 102 and 104 are stored out of the way making room for optional spears 202 to be used in tight quarters. In the vertical orientation prongs 102 and 104 further function as a headboard (see FIG. 18). The presence of the headboard facilitates handing multiple bales at a time (see FIG. 19). For example, when two or more bales are stacked, one on another, the lower bale may be speared, the apparatus, including spears 202, may be tipped up slightly causing the upper bale(s) to rest against the headboard. When the wrap material has been cut, and prongs 102 and 104 optionally moved apart, prongs 102 and 104 may also be rotated up to help separate wrap material from the bale contents.

In an alternative embodiment, the apparatus is configured with a plurality of vertical supports configured to prevent a bale 1402, 1602, or 1702, stacked on the grasp bale, from sliding off the grasp bale in the direction of the tractor or vehicle to which the apparatus is attached.

In a preferred embodiment, the apparatus is configured with mounting features 802 conforming to a mounting standard. In a preferred embodiment, these features are detachably mounted to the rest of the apparatus such that the apparatus may be configured to attach to a variety of mounting standards by replacing one set of mounting features with a different set of mounting features.

In operation, the apparatus is preferably used in the following manner. The apparatus is mechanically attached to a tractor or vehicle by placing features of the apparatus adjacent features of the tractor and securing the apparatus to the tractor. The apparatus is also energetically attached to the tractor such that energy from the tractor may be transferred to the apparatus. In a preferred embodiment, this energetic attachment is hydraulic. In alternative embodiments, the energetic attachment is electrical (e.g. to power a linear actuator or motor) or mechanical (e.g. to power a pulley or scissor system). The combined tractor/apparatus is moved so the apparatus is adjacent a bale with the bale between projections of the apparatus 2002. When a “round” bale is handled, the apparatus is preferably placed adjacent a round face of the bale and the prongs are preferably placed at, or slightly below, the horizontal diameter of the bale. When a “square” bale is handled, it is picked up in an orientation which places wrap material adjacent the projections of the apparatus. The distance between projections of the apparatus is decreased squeezing the bale between the projections 2004. The height of the projections above the ground is then increased lifting the bale off the ground. The combined tractor/apparatus is then driven to the location at which the contents of the bale are to be distributed/released 2006. The means to capture the material used to bale the vegetation are then engaged 2008. The means to sever the wrap material are activated thereafter or simultaneously 2008. The baled material is then released, preferably by increasing the distance between the projections allowing the baled material to fall from between the projections 2010. The combined tractor/apparatus is then withdrawn/relocated from where the baled material was deposited. The combined tractor/apparatus is then relocated to an area where the wrap material is to be deposited 2012. The wrap material is then released 2014. The entire process is then repeated for each bale to be distributed.

For purposes of this application, including claims, the following definitions are used. Plurality means one or more.

### BRIEF DESCRIPTION OF DRAWINGS

FIG. 1 shows the apparatus with the prongs in a retracted position.

FIG. 2 shows the apparatus with installed spears with the prongs in a retracted position.

FIG. 3 shows the apparatus with installed spears with the prongs in an extended position.

FIG. 4 shows the apparatus with installed spears with the prongs in a vertical position.

FIG. 5 shows the apparatus with installed spears with the cutting prong exploded.

FIG. 6 shows an exploded view of components of the retention prong.

FIG. 7 shows an exploded view of the squeeze/pivot mechanism.

FIG. 8 shows an exploded view of a quick-detach mechanism.

FIG. 9a shows a top view of the cutting prong with the blade in a partially extended position.

FIG. 9b shows a top side view of the cutting prong with the blade in a partially extended position.

FIG. 10a shows a top view of the cutting prong with the blade in an extended position.

FIG. 10b shows a top side view of the cutting prong with the blade in an extended position.

FIG. 11a shows a top view of the retention prong with the hooks in a retracted position.

FIG. 11b shows a top side view of the retention prong with the hooks in a retracted position.

FIG. 12a shows a top view of the retention prong with the hooks in a partially extended position.

FIG. 12b shows a top side view of the retention prong with the hooks in a partially extended position.

FIG. 13a shows a top view of the retention prong with the hooks in an extended position.

FIG. 13b shows a top side view of the retention prong with the hooks in an extended position.

FIG. 14 shows the apparatus lifting a single square bale using the prongs.

FIG. 15 shows the apparatus lifting two square bales using the prongs.

FIG. 16 shows the apparatus lifting a single round twine-wrapped bale using the prongs.

FIG. 17 shows the apparatus lifting a single round net-wrapped bale using the prongs.

FIG. 18 shows the apparatus lifting a single round bale using the spears.

FIG. 19 shows the apparatus lifting two round bales using the spears.

FIG. 20 shows a flow chart of using the apparatus too feed a bale.

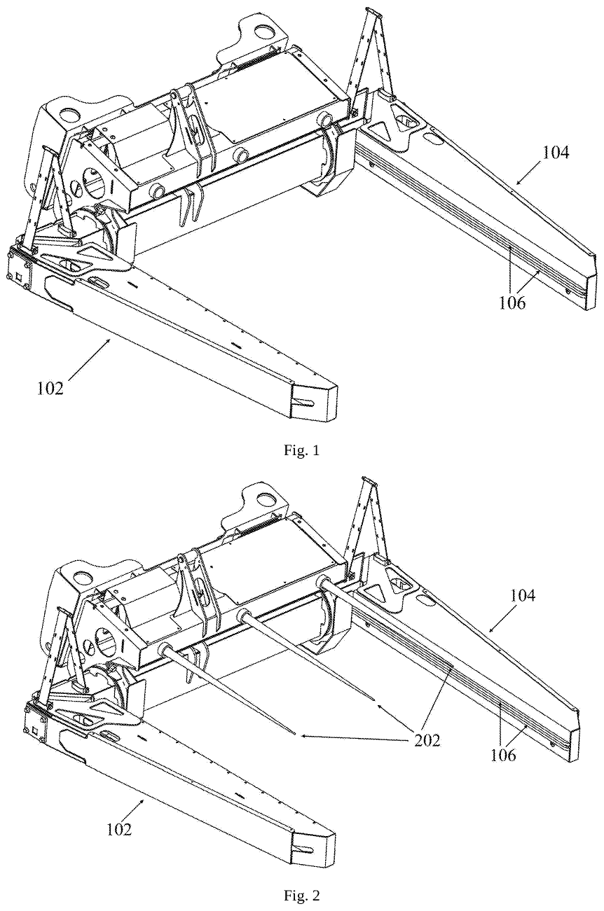

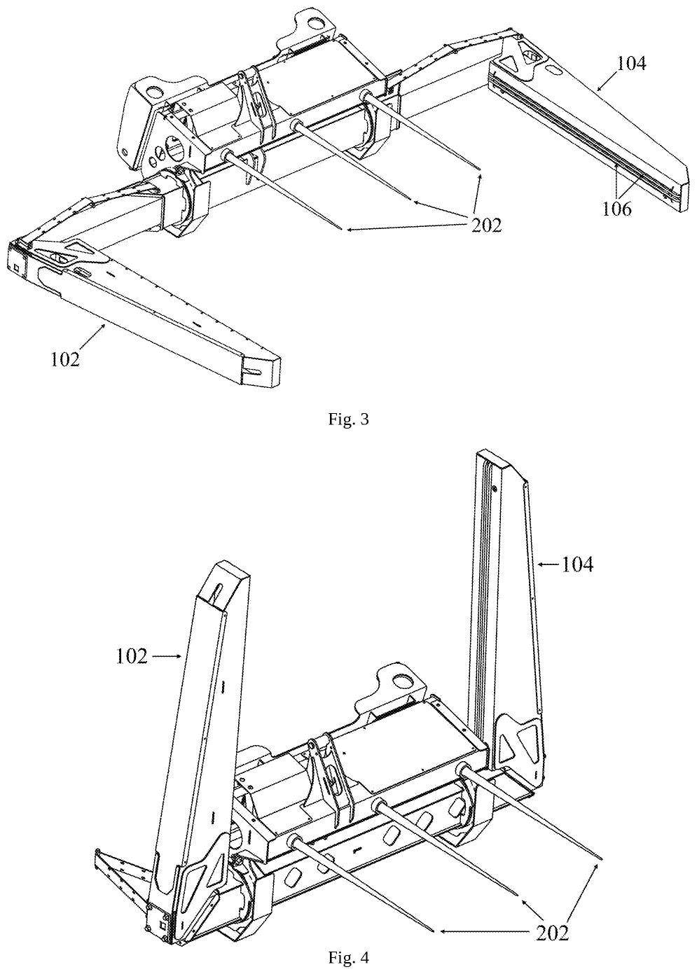

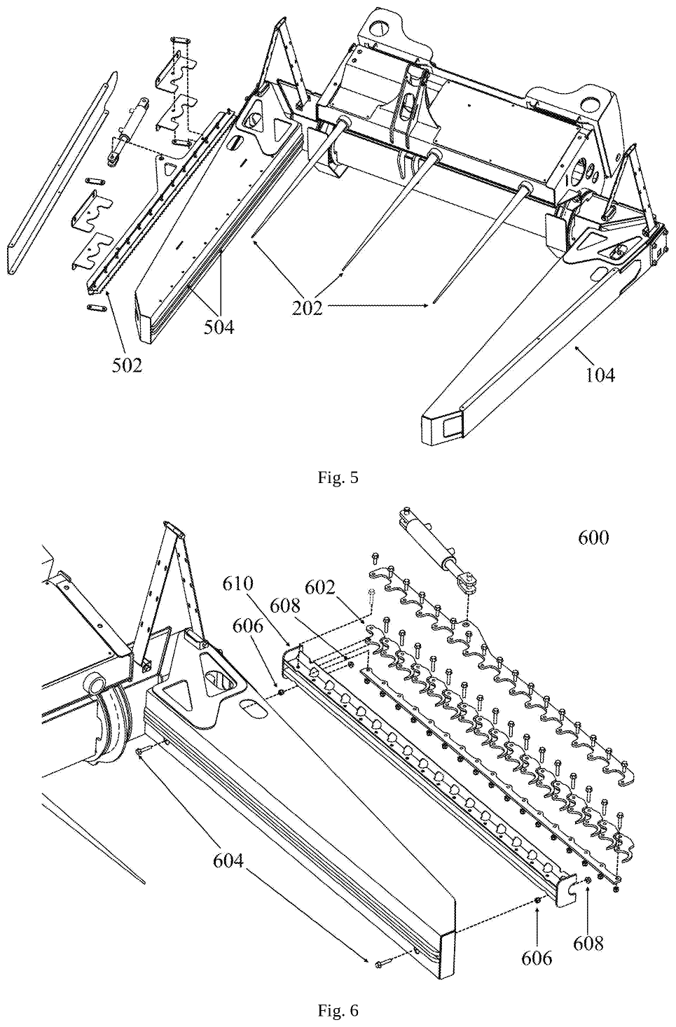

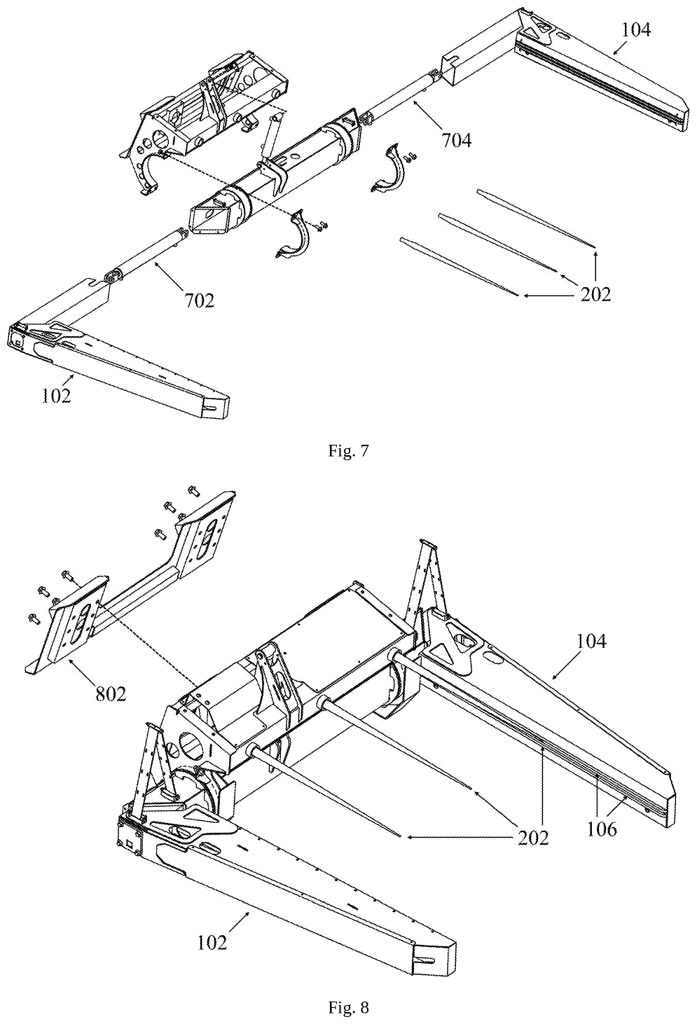

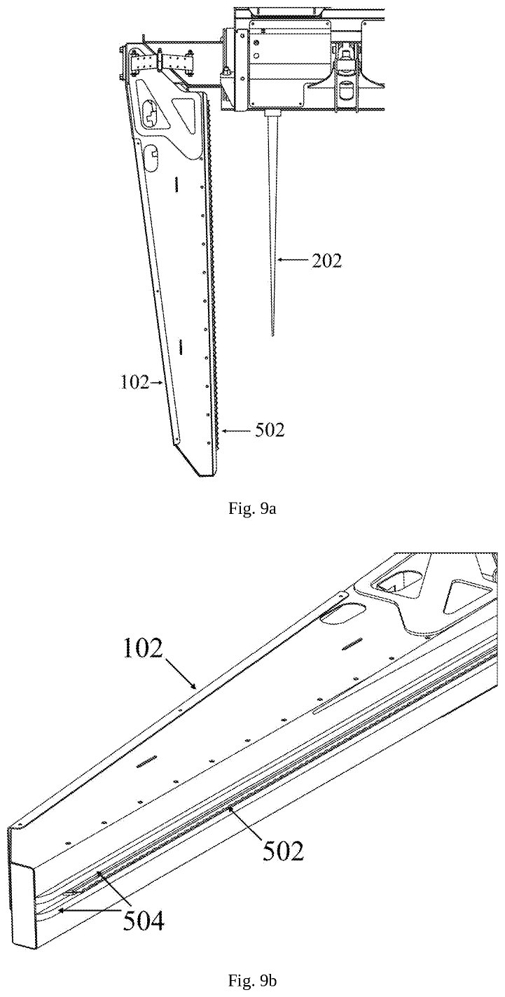

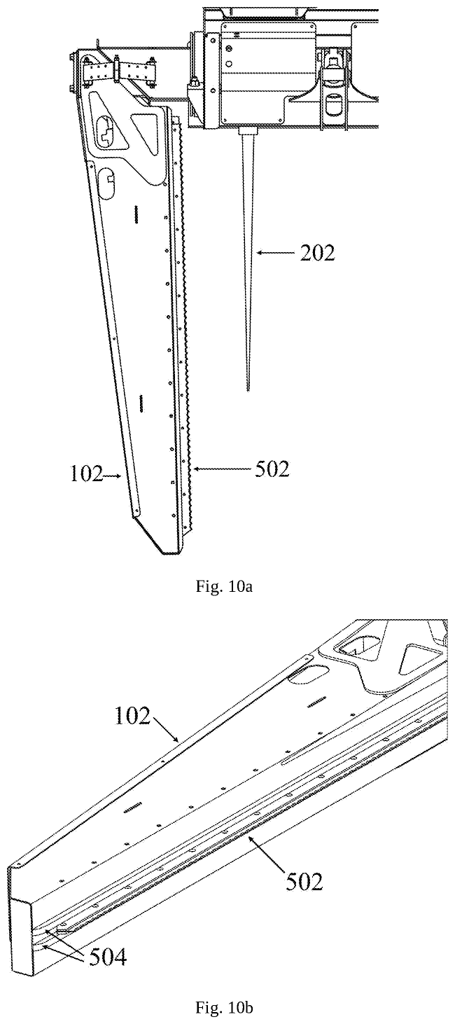

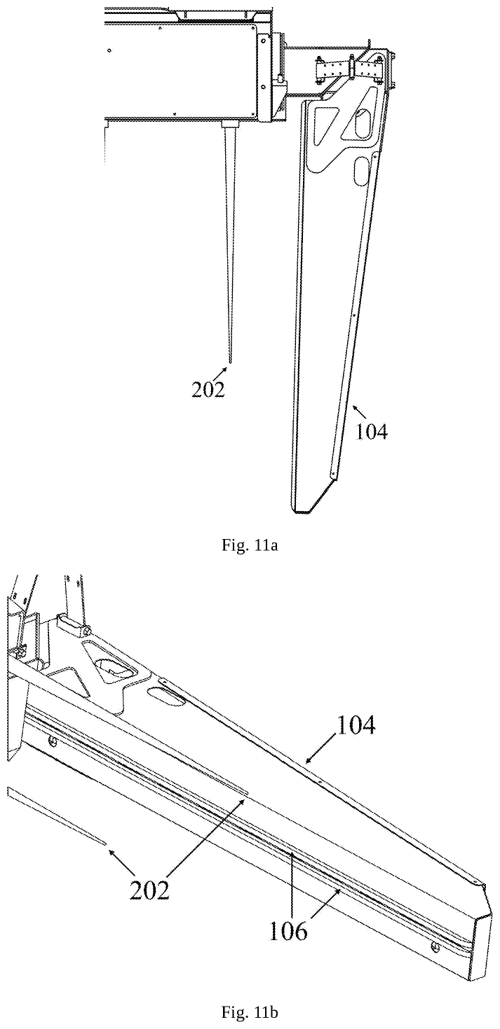

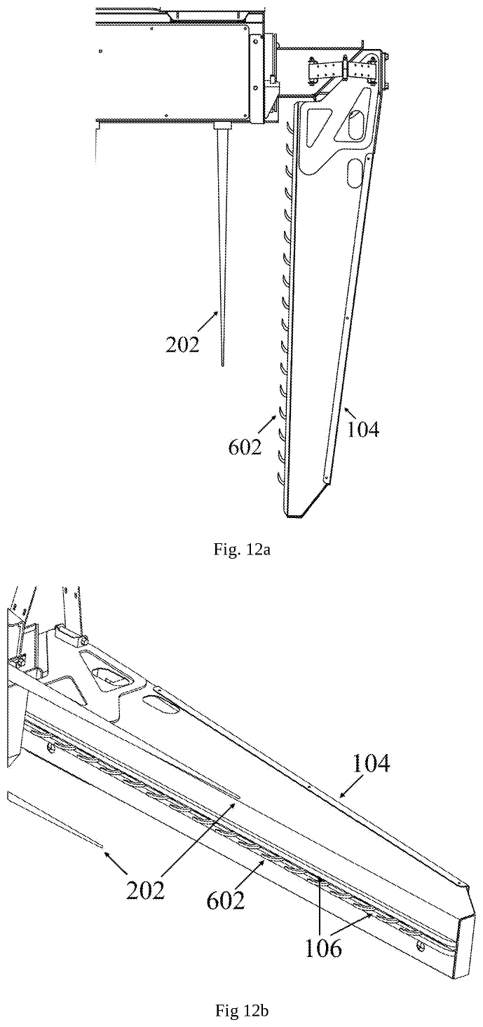

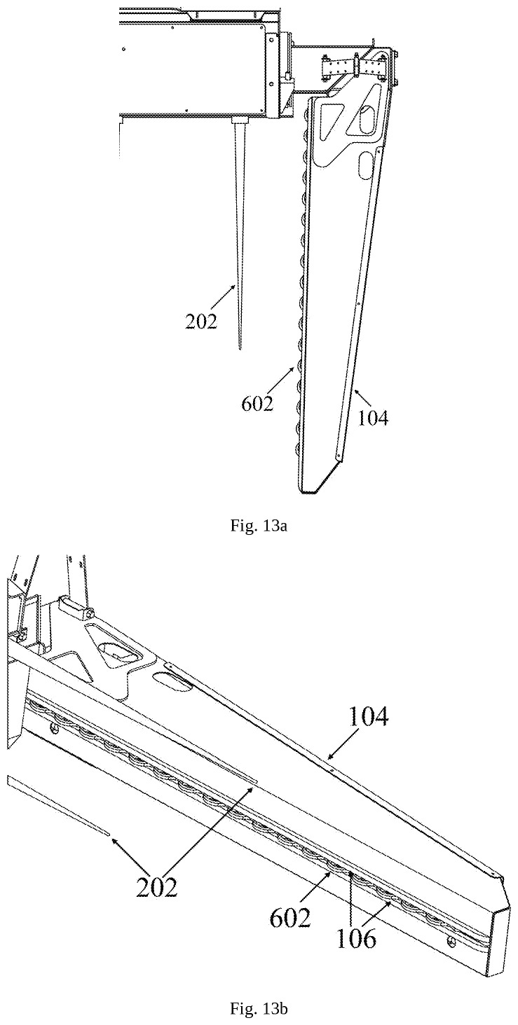

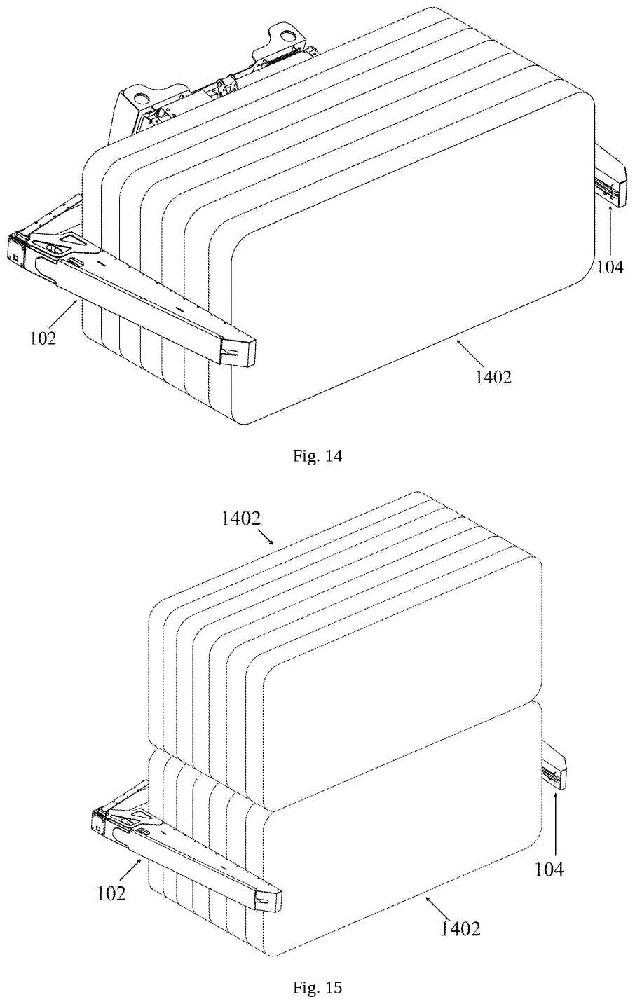

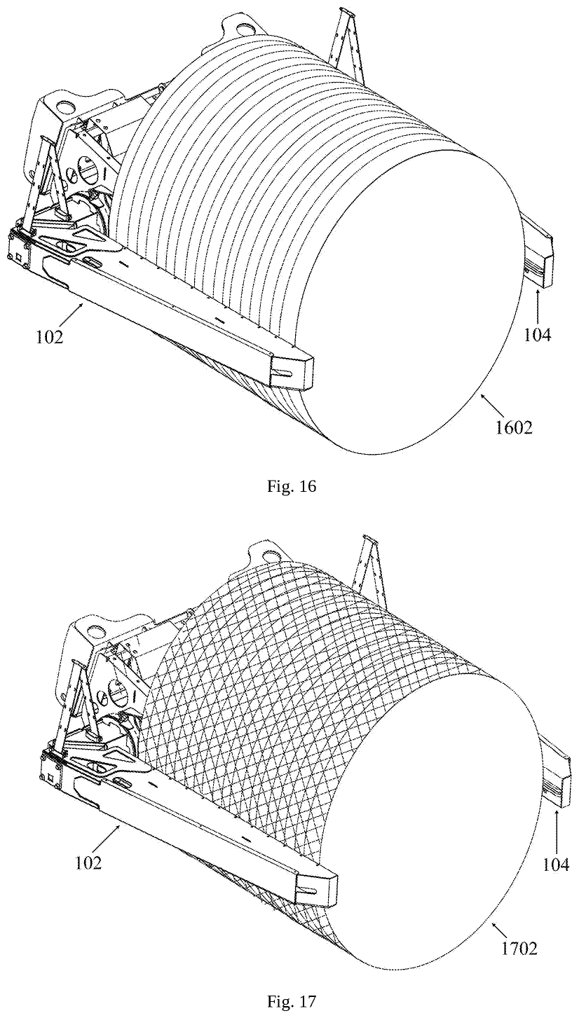

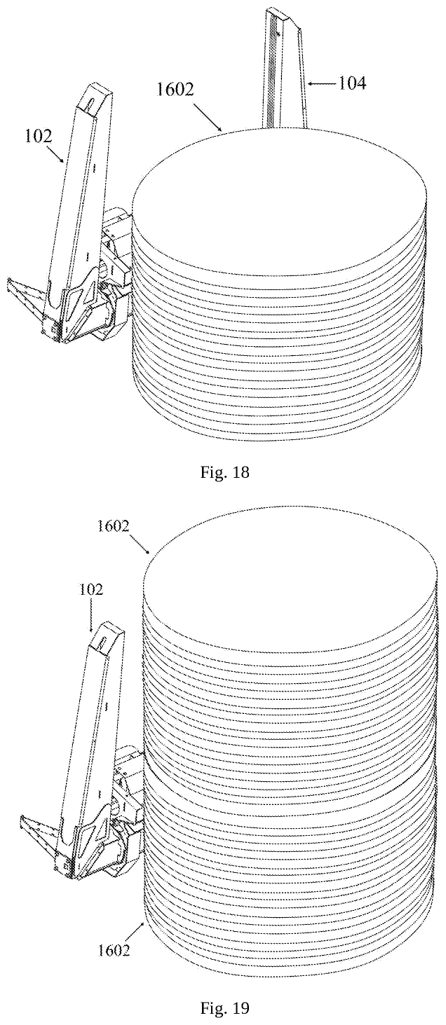

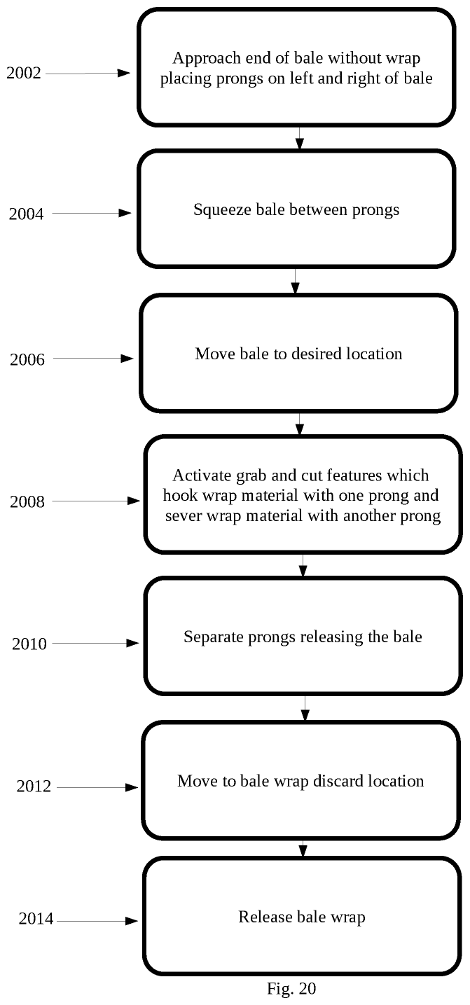

### BEST MODE FOR CARRYING OUT THE INVENTION

The apparatus is preferably attached to a tractor or other locomotive apparatus which is configured to provide hydraulic power to attached accessories. The apparatus is preferably attached using a quick attach/detach configuration shared among accessories and a variety of quick attach/detach adapters may be attached to the apparatus to allow it to be mounted to various quick attach/detach standards used by different manufactures, industries, etc.

The apparatus is preferably connected to three separate hydraulic circuits on the tractor. One circuit is used to power/control the prongs squeezing a bale. A second circuit is used to power/control features which grab and cut the material forming the bale. A third circuit is used to rotate the prongs between horizontal and vertical orientations.

The apparatus preferably has two prongs. One prong is configured with features to grab the net wrap, twine, silage wrap or other material forming the bale. The other prong is configured with features to cut the net wrap, twine, silage wrap, or other material forming the bale. By placing cutting and grabbing features on opposite sides of a bale, the length of strings or wrap hang down from the features grabbing the net wrap, twine, silage wrap or other material forming the bale is minimized. The apparatus is also preferably configured with multiple spears parallel to the prongs when the prongs are in a horizontal orientation. The spears are configured to pierce the bale(s) being handled.

A bale, regardless of whether it has a generally cylindrical (“round”), rectangular prism (“square”) shape is then approached. The bale is approached with the faces of the bale having exposed wrap on the outside. The tractor is then driven up to the end of the bale with the spear(s) piercing the bale. The prongs are then actuated and caused to clamp the bale. Force equalization features cause approximately equal force to be applied to the bale from either side without significantly changing the position of the bale relative to the spear(s). Sufficient force is applied using the prongs to provide relatively consistent contact along the length of the bale and reduce bulging between twine strands or wrap material.

The apparatus is then lifted if the bale is to be “fed” at another location and the tractor is driven to the desired location. The cut/capture features are activated. When they are activated, the capture hooks swing out into the bale along substantially the entire length of the prong. Because the hooks cover the length of the prong, the wrap, regardless of the material, is captured along with a minimal amount of the baled material. The hooks preferably swing toward the tractor. Simultaneously, or shortly thereafter, the blade begins an orbital movement out, between the ribs, into the bale, and back into the prong. The blade is preferably serrated such that it saws as it orbits through the exterior region of the bale.

The pressure between the prongs is then reduced by moving the prongs apart. The tractor is then reversed, and or the spears are tipped down to aid in removing the bale from between the prongs. The prongs may also optionally be rotated in/toward a vertical orientation to aid in separating the baling material from the bale contents. The tractor is then driven to where the wrap will be deposited. The capture features are then deactivated and gravity pulls the baling material away. The process is then repeated as necessary.

When using the apparatus to move, rather than feed, bales, the prongs are rotated to a vertical orientation where they serve as a headboard. The spears are then used to move bales in a manner well known in the art, with the exception of improved handing of stacked bales due to the headboard.

### INDUSTRIAL APPLICABILITY

The apparatus has particular applicability in agricultural settings where bundles of material (grass, hay, straw, etc) are moved and fed to animals. The apparatus reduces the need for individuals to mount and dismount a vehicle when moving bales, dispersing bale contents, and accumulating bale material for discard/disposal.

### SEQUENCE LISTING

Not Applicable

### SEQUENCE LISTING FREE TEXT

Not Applicable

1. An apparatus for separating bale contents from wrap material comprising:
A. two or more prongs, at least one of which is movable toward and away from another of said prongs wherein:
i. at least one of said prongs is configured with means for cutting wrap material constraining a bale without cutting through substantially all of the bale; and
ii. another of said prongs is configured with means for capturing and retaining wrap material constraining the bale.

2. The apparatus of claim 1 wherein:
A. at least one of said prongs is linearly movable toward and away from a point between said prongs.

3. The apparatus of claim 2 wherein said means for cutting wrap material constraining a bale without cutting through substantially all of the bale comprise:
A. a movable blade.

4. The apparatus of claim 3 wherein:
A. said movable blade extends beyond a face of said prong when cutting wrap material constraining a bale.

5. The apparatus of claim 4 wherein:
A. said movable blade does not extend beyond a face of said prong when not cutting wrap material constraining a bale.

6. The apparatus of claim 5 wherein:
A. said movable blade is movable along an arc about a point behind a face of said prong.

7. The apparatus of claim 3 wherein:
A. said prong configured with means for cutting wrap material constraining a bale without cutting through substantially all of the bale further comprises:
i. a plurality of ribs which extend from a face of said prong adjacent said means for cutting wrap material.

8. The apparatus of claim 7 wherein:
A. said plurality of ribs which extend from a face of said prong adjacent said means for cutting wrap material constraining a bale:
i. extend from said face on two sides of said means for cutting wrap material constraining a bale.

9. The apparatus of claim 2 wherein:
i. said means for capturing and retaining wrap material constraining the bale extend along substantially all of a face of said prong.

10. The apparatus of claim 9 wherein:
A. said means for capturing and retaining wrap material constraining the bale comprise a plurality of curved members.

11. The apparatus of claim 9 wherein:
A. said means for capturing and retaining wrap material constraining the bale do not extend beyond a face of said prong when neither capturing nor retaining wrap material.

12. The apparatus of claim 11 wherein:
A. said means for capturing and retaining wrap material constraining the bale extend beyond a face of said prong when capturing or retaining wrap material.

13. The apparatus of claim 12 wherein:
A. the distance said means for capturing and retaining wrap material constraining the bale extend beyond a face of said prong when capturing or retaining wrap material is adjustable.

14. The apparatus of claim 9 wherein:
A. said prong configured with means for capturing and retaining wrap material constraining the bale further comprise:
i. a plurality of ribs which extend from a face of said prong adjacent said means for capturing and retaining wrap material constraining the bale.

15. The apparatus of claim 14 wherein:
A. said plurality of ribs which extend from a face of said prong adjacent said means for capturing and retaining wrap material constraining the bale:
i. extend from said face on two sides of said means for capturing and retaining wrap material constraining the bale.

16. The apparatus of claim 1 further comprising:
A. a plurality of spears configured to pierce a plurality of bales being handled.

17. The apparatus of claim 16 wherein:
A. said plurality of prongs are configured to rotate from a horizontal orientation to a vertical orientation.

18. The apparatus of claim 17 wherein said two or more prongs are movable and connected through a control system which equalizes pressure by the prongs such that approximately equal pressure is applied by two or more prongs on a bale being handled.

19. The apparatus of claim 1 wherein:
A. said apparatus is configured to be attached and detached from a motorized vehicle using a mounting standard shared with other detachable apparatuses.

20. A method of separating bale contents from wrap material comprising:
A. clamping a bale between a plurality of prongs, at least one of which is movable laterally toward another;
B. capturing wrap material constraining the bale;
C. cutting wrap material constraining the bale without cutting through substantially all of the bale;
D. releasing the bale contents by moving at least one of the plurality of prongs laterally away from another; and
E. separately releasing wrap material which previously constrained the bale.
